(19) United States
(12) Patent Application Publication
(10) Pub. No.: US 2010/0072665 A1
(43) Pub. Date: Mar. 25, 2010

(54) THERMAL IMPRINTING DEVICE AND THERMAL IMPRINTING METHOD

(75) Inventors: Tetsuya Imai, Tsurugashima-shi (JP); Kazunobu Hashimoto, Tsurugashima-shi (JP)

Correspondence Address: SUGHRUE MION, PLLC, 2100 PENNSYLVANIA AVENUE, N.W., SUITE 800, WASHINGTON, DC, 20037, US

(73) Assignee: Pioneer Corporation, Meguro-ku, Tokyo (JP)

(21) Appl. No.: 12/594,126

(22) PCT Filed: Mar. 30, 2007
(86) PCT No.: PCT/JP2007/057266

§ 371 Date: Nov. 2, 2009

(51) Int. Cl. B29C 59/02

(52) U.S. Cl. 264/293; 425/385

(57) ABSTRACT

A thermal imprinting device, including: a mold on the surface of which is formed a concavity and convexity pattern to be formed in a transfer layer; a pressing mechanism which brings the mold into close contact with the transfer layer and performs pressing; and a pair of heating mechanisms arranged at positions enclosing the mold and the transfer substrate to heat the mold and the transfer substrate. At least one of the heating mechanisms has a plurality of heating regions comprising a central heating region and at least one peripheral heating region surrounding the central heating region, and has different heating abilities for each of the heating regions.

### TECHNICAL FIELD

This invention relates to a thermal imprinting device and a thermal imprinting method.

### BACKGROUND ART

Lithography techniques generally used as techniques for pattern formation include photolithography and, for processing of numerous small lots, direct electron beam drawing and similar. However, these lithographic techniques each have their various problems. Photolithography is limited by the resolution due to the light wavelength, and transfer at 100 nm or less is difficult. In direct electron beam drawing, the throughput per unit time is inadequate, and the method is not suited to mass production. In order to overcome such limits to pattern fineness and processing capacity of lithography techniques, which constitute a core technology among fine-structure device manufacturing technologies, much research on lithography employing novel methods is underway. Among this, research on nanoimprinting lithography as a technology enabling fabrication of nanometer-order design rules and being suitable for mass production is attracting attention. In this technology, a mold (die) having a nanometer-scale concavity and convexity pattern is pressed onto a transfer layer on a substrate, and the fine concavity and convexity pattern of the mold is transferred to the transfer layer, to obtain a substrate on which is formed a fine concavity and convexity pattern.

Thermal imprinting is known as one nanoimprinting lithography method. FIG. 1 shows the general flow of processes in this thermal imprinting. First, a mold 3 in which is formed a fine concavity and convexity pattern, and a transfer substrate having a transfer layer 2 formed by applying transfer material onto the surface of a substrate 1, are prepared. In thermal imprinting, PMMA (polymethyl methacrylate) or another thermoplastic resin is used as the transfer material employed in the transfer layer. The mold 3 and the substrate 1 on which is formed the transfer layer 2 are each heated at least to the softening temperature of the transfer material used in the transfer layer, such as for example to approximately 200° C. ((a) of FIG. 1). Next, by bringing the mold 3 into contact with the transfer layer 2 and applying pressure, the transfer layer 2 is deformed into the shape of the concavity and convexity pattern formed in the mold 3. And, while maintaining the pressed state, the mold 3 and the substrate 1 are cooled, hardening the transfer layer 2 ((b) of FIG. 1). After the transfer layer 2 has hardened sufficiently, the mold 3 is separated from the transfer substrate. At this time, portions equivalent to protrusions of the mold 3 remain as thin remaining film on the substrate 1 ((c) in FIG. 1). Next, oxygen reactive ion etching (RIE) or similar is used to remove the remaining film, exposing the surface of the substrate 1 ((d) of FIG. 1). By means of the above processes, formation of a fine concavity and convexity pattern on a substrate using an imprinting process is completed. Thereafter, etching may be performed using the transfer layer 2 in which the fine concavity and convexity pattern is formed as a mask, or after evaporation deposition of aluminum or another metal, a lift-off method or similar may be used to remove the transfer layer 2, enabling use in fabricating fine structures, wiring, and similar.

In this thermal imprinting process, generally it is desirable that a uniform pressure be applied to the entire transfer face, and that the entire transfer layer be heated uniformly. However, in actuality the transfer layer is thin, and the state is such that the mold and the substrate are almost in contact with each other, so that the pressing distribution during mold pressing is such that the pressure is low near the mold center and the pressure is higher near the mold edges, as shown in FIG. 2. This phenomenon of non-uniform mold pressure within the same plane is known as an edge effect or center-depression phenomenon in the mechanics of elastic contacts. Due to this phenomenon, the pattern is not transferred in portions where the pressure is low, and pattern deformation occurs in portions where the pressure is high, so that a problem occurs in which the fine concavity and convexity pattern of the mold cannot be uniformly transferred to the entire face of the transfer layer. In each of the references described below, innovations in the mold shape and configuration to render the mold pressure distribution more uniform are described.

In Patent Reference 1, a disclosure is made in which, in a transfer device, by holding a master (mold) and a substrate (transfer substrate) with an elastic member therebetween, uniform pressure can be applied to a disc to perform uniform transfer. In Patent Reference 2, a disclosure is made in which an elastic member is provided on the periphery of a master and substrate, and when applying pressure to the master and substrate the elastic member is deformed, stress in the direction separating the master and substrate occurs, and the concentration of stress at the edge portions of the master and substrate is alleviated, and uniform transfer can be performed. In Patent Reference 3, a disclosure is made in which, by using a stamper having a layer comprising a hard material in which a pattern is formed and a rear-face layer comprising compressible material, the pressing force when performing imprinting can be made uniform. In Patent Reference 4, a method is disclosed in which the mold pattern height in the pressing direction is reduced on the periphery compared with the center of the pressing face, so that non-uniformity of pressing pressure over the pressing face is alleviated.

### Patent Reference 1: Japanese Patent Application Laid-open No. 2002-100038

### Patent Reference 2: Japanese Patent Application Laid-open No. 2002-100079

### Patent Reference 3: Japanese Patent Application Laid-open No. 2005-183985

### Patent Reference 4: Japanese Patent Application Laid-open No. 2002-289560

### DISCLOSURE OF THE INVENTION

### Technical Problems

However, if an elastic member is provided in the pressing mechanism as described in Patent References 1 through 3, there is the concern that the elastic member may undergo plastic deformation due to the pressure applied. Hence a plurality of elastic members that cope with pressure applied are necessary, and consequently the number of components is increased, and so workability and ease of maintenance are worsened. On the other hand, if the height of the mold pattern is made different according to the position in the pressing face, as described in Patent Reference 4, each time the applied pressure and the pattern to be formed are altered, a mold conforming to the altered conditions must be prepared. And, because the mold shape is determined according to the imprinting conditions, there is the concern that a slight fluctuation in conditions may mean uniform transform cannot be obtained.

In order to obtain a uniform transfer pattern in a thermal imprinting process, the heating conditions are important parameters in addition to the pressing force at the time of mold pressing, and the combination of these is important. In general, when attempting to obtain a satisfactory transfer pattern in a thermal imprinting process employing a thermoplastic resin, the transfer substrate and mold heating temperature should be set according to the pressing force during mold pressing; when the pressing force is low the transfer temperature should be high, and when the transfer temperature is low the pressing force should be high.

This invention was devised in light of the above, and has as an object the provision of a thermal imprinting device and a thermal imprinting method which correct non-uniform pressure distributions during mold pressing in thermal imprinting processes, and enable formation of uniform transfer patterns.

### Solution to Problems

A thermal imprinting device of this invention, which heats a mold on the surface of which a concavity and convexity pattern is formed and a transfer substrate having a thermoplastic transfer layer on a substrate to a prescribed temperature, and then transfers the concavity and convexity pattern shape of the mold to the transfer layer, the device comprises: a pressing mechanism which brings the mold and the transfer layer into close contact to perform pressing; and a pair of heating mechanisms arranged at positions enclosing the mold and the transfer substrate to heat the mold and the transfer substrate. At least one of the heating mechanisms has a plurality of heating regions comprising a central heating region and at least one peripheral heating region surrounding the central heating region, and each of the heating regions has different heating ability.

Further, a thermal imprinting method of this invention, in which a transfer substrate having a thermoplastic transfer layer on a substrate and a mold, on the surface of which is formed a concavity and convexity pattern are heated and then the mold is pressed against the transfer layer to transfer the concavity and convexity pattern shape of the mold to the transfer layer, the method comprises: a setup step of setting up the transfer substrate and the mold such that the transfer layer and the concavity and convexity pattern formation face of the mold are opposed; a heating step of heating the mold and the transfer substrate, and causing softening of the transfer layer; a pressing step of bringing the transfer layer and the concavity and convexity pattern formation face of the mold into close contact to perform pressing; a hardening step of cooling the transfer substrate and the mold, and causing hardening of the transfer layer; and a separation step of separating the transfer substrate and the mold. The heating step is a step of heating the transfer layer at a non-uniform temperature distribution in the circumferential direction of the transfer substrate.

### BRIEF DESCRIPTION OF THE DRAWINGS

FIG. 1 shows the general flow of processes in thermal imprinting;

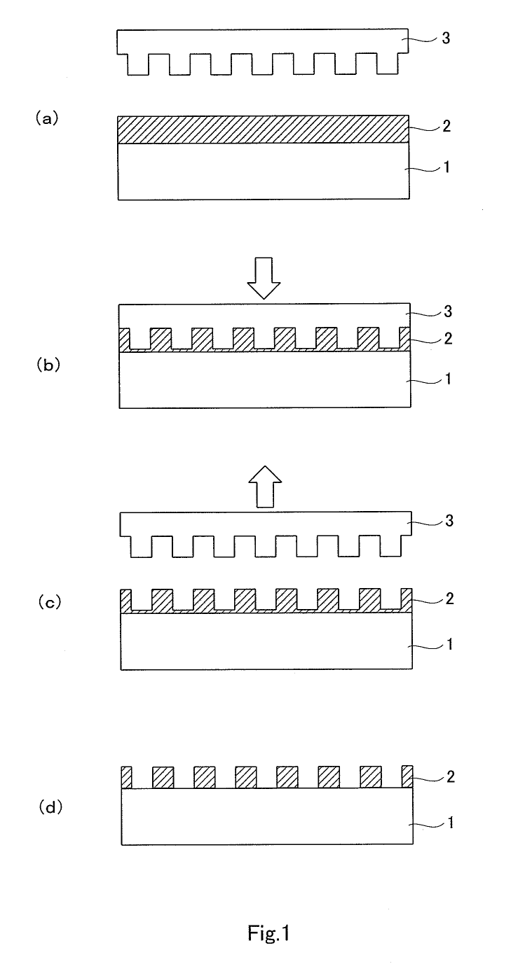

FIG. 2 shows the pressing force distribution during mold pressing;

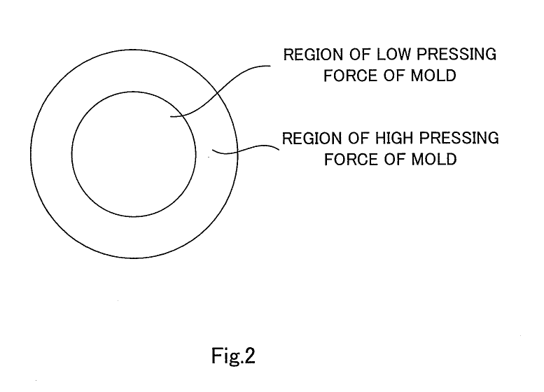

FIG. 3 is a cross-sectional view showing the configuration of the thermal imprinting device of a first embodiment of the invention;

FIG. 4 is a top view of a heating mechanism comprised by a thermal imprinting device of the invention;

FIG. 5 is a process diagram showing a method of discrete track media manufacture employing the imprinting method of an embodiment of the invention;

FIG. 6 is a cross-sectional view showing the configuration of a first modified example of the thermal imprinting device of the first embodiment of the invention;

FIG. 7 is a cross-sectional view showing the configuration of a second modified example of the thermal imprinting device of the first embodiment of the invention;

FIG. 8 is a cross-sectional view showing the configuration of a third modified example of the thermal imprinting device of the first embodiment of the invention;

FIG. 9 is a cross-sectional view showing the configuration of a fourth modified example of the thermal imprinting device of the first embodiment of the invention;

FIG. 10 is a top view of a heating mechanism in the fourth modified example of the thermal imprinting device of the first embodiment of the invention;

FIG. 11 is a cross-sectional view showing the configuration of a fifth modified example of the thermal imprinting device of the first embodiment of the invention;

FIG. 12 is a cross-sectional view showing the configuration of the thermal imprinting device of a second embodiment of the invention;

FIG. 13 is a cross-sectional view showing the configuration of a first modified example of the thermal imprinting device of the second embodiment of the invention;

FIG. 14 is a cross-sectional view showing the configuration of a second modified example of the thermal imprinting device of the second embodiment of the invention;

FIG. 15 is a cross-sectional view showing the configuration of a third modified example of the thermal imprinting device of the second embodiment of the invention;

FIG. 16 is a cross-sectional view showing the configuration of a fourth modified example of the thermal imprinting device of the second embodiment of the invention;

FIG. 17 is a cross-sectional view showing the configuration of a fifth modified example of the thermal imprinting device of the second embodiment of the invention;

FIG. 18 is a cross-sectional view showing the configuration of a sixth modified example of the thermal imprinting device of the second embodiment of the invention; and,

FIG. 19 is a cross-sectional view showing the configuration of the thermal imprinting device of a third embodiment of the invention.

### REFERENCE SIGNS LIST

11 Mold holding portion
12 Mold
13 Transfer substrate holding portion
20 Transfer substrate
22 Transfer layer
30 Heating mechanism
31 Heating member
32a Heat-generating element
32b Heat-generating element
33 Adiabatic member
100 Temperature controller

### BEST MODE FOR CARRYING OUT THE INVENTION

Below, embodiments of the invention are explained referring to the drawings. In the drawings described below, constituent elements and portions which are effectively the same or equivalent are assigned the same reference symbols.

### First Embodiment

The thermal imprinting device of a first embodiment of the invention has a heating mechanism which heats a mold and a transfer substrate. This heating mechanism has a heat source which is divided into a region corresponding to the interior/intermediate portion of the mold and transfer substrate, and a region corresponding to the peripheral portion of the mold and transfer substrate. And, by causing the arrangement of the heat source within the heating mechanism to be different in each of the regions according to the pressing force distribution during mold pressing, a temperature distribution is formed such that a non-uniform pressing force distribution during mold pressing can be corrected.

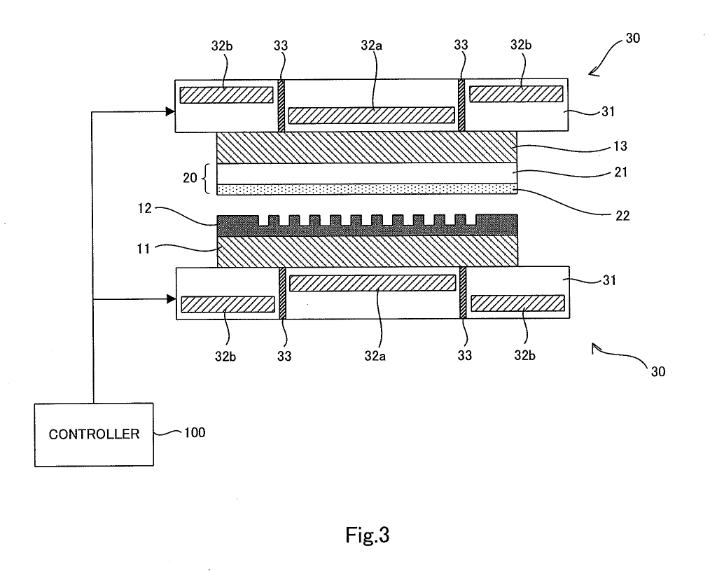

FIG. 3 is a cross-sectional view showing the configuration of the thermal imprinting device of the first embodiment of the invention. The mold holding portion 11 has a flat mold-holding face; the mold 12 is mounted on the mold-holding face by, for example, vacuum suction, electrostatic chucking, mechanical clamping, or another method, to hold the mold 12. A fine concavity and convexity pattern for transfer to the transfer layer 22 is formed in the surface of the mold 12, fabricated using, for example, silicon, glass, a nickel alloy, or similar. The transfer substrate holding portion 13 has a flat transfer substrate-holding face opposing the mold holding portion 11; the transfer substrate 20 is mounted on the transfer substrate-holding face by, for example, vacuum suction, electrostatic chucking, mechanical clamping, or another method, to hold the transfer substrate 20. The transfer substrate 20 is the object for processing by a thermal imprinting device of this invention; the substrate 21 is for example a silicon substrate, glass substrate, aluminum substrate, or other flat plate, and a silicon wafer, quartz substrate, aluminum substrate, or else a semiconductor layer, magnetic layer, ferroelectric layer, or other layer deposited on these substrates, can be used. On this substrate 21, a transfer layer 22 is formed by using spin coating or another method to apply a thermoplastic resin or other material, which is the transfer material. As the transfer layer 22 on the substrate 21, for example PMMA (polymethyl methacrylate), polycarbonate, or another thermoplastic resin material, as well as another material having fluidity when heated and to which the pattern shape of the mold 12 can be transferred, may be used; for example, a metallic glass or similar can be used. Further, if the material of the substrate 21 has fluidity when heated, so that the pattern shape of the mold 12 can be transferred, such as for example a resin film, bulk resin, low-melting point glass or similar, then the upper-layer portion of the substrate 21 can be treated as the transfer layer 22, and the pattern shape can be transferred directly without applying a transfer material onto the substrate 21.

The heating mechanisms 30 abut the faces on the sides opposite the holding faces of the mold holding portion 11 and the transfer substrate holding portion 13, and heat the mold 12 and the transfer substrate 20 via the mold holding portion 11 and the transfer substrate holding portion 13. The transfer layer 22 formed on the substrate 21 is softened by heat provided from the heating mechanisms 30, so that pattern transfer becomes possible.

The heating mechanisms 30 comprise heat-generating elements 32a and 32b, comprising electrical heaters, lamp heaters, thermostatic devices using liquid or gas heat sources, or similar; heating members 31, comprising a material with comparatively high thermal conductivity such as a metal or similar, having the heat-generating elements 32a and 32b therewithin; adiabatic members 33 provided between the heat-generating elements 32a and 32b; and, a temperature controller 100 which controls the heat-generating temperatures of the heat-generating elements 32a and 32b.

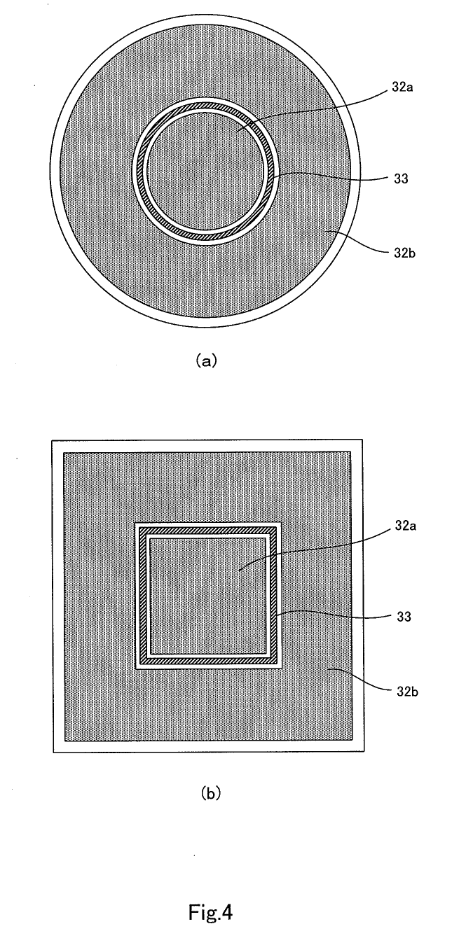

The outer shape of the heating mechanisms 30 can be made any shape, according to the outer shapes of the transfer substrate 20 and mold 12. Here, examples of top views of heating mechanisms 30 are shown in (a) and (b) of FIG. 4. The outer shape of the heating mechanisms 30 may for example be formed in a disc shape similar to the outer shape of a transfer substrate 20 and mold 12, as shown in (a) of FIG. 4. That is, by making the shape of the heating mechanisms 30 a shape similar to that of the transfer substrate 20 and mold 12, a temperature distribution can be formed corresponding to the above-described edge effect. In this case, it is desirable that the mold holding portion 11 and transfer substrate holding portion 13 also have disc shapes. As shown in FIG. 3 and (a) of FIG. 4, the heat-generating elements 32a provided in the heating mechanism 30 are circular, extending the regions corresponding to the interior/intermediate portions of the transfer substrate 20 and mold 12, and heating the interior/intermediate portions of the transfer substrate 20 and mold 12. On the other hand, the heat-generating elements 32b have a ring shape, arranged so as to surround the periphery of the heat-generating elements 32a, and extend the regions corresponding to the peripheral portions of the transfer substrate 20 and mold 12, and heating the peripheral portions of the transfer substrate 20 and mold 12. An adiabatic member 33 is provided between the heat-generating elements 32a and 32b, so that there is no mutual interference of heat generated in each region. That is, a heating mechanism 30 forms two heating regions by means of heat-generating elements 32a, 32b divided into an interior/intermediate portion and a peripheral portion, and an adiabatic member 33 provided therebetween. Further, as shown in FIG. 3, the heat-generating element 32b is arranged at a position further removed from the transfer substrate 20 and mold 12 than the heat-generating element 32a within the heating member 31. The temperature controller 100 executes control such that the heat-generating temperatures of the heat-generating elements 32a and 32b are the same. Due to the configuration of the heating mechanisms 30, the surface temperature at the heating face of a heating mechanism 30 (that is, the face of the heating mechanism 30 abutting the mold holding portion 11 and transfer substrate holding portion 13) assumes a temperature distribution which is higher in the interior/intermediate portion than in the peripheral portion. That is, the heating ability of the heating mechanism 30 is different in each of the heating regions. The heating ability is the magnitude of the amount of heat which can be transferred to a heated member per unit time.

Through this temperature distribution on the heating faces of the heating mechanisms 30, the peripheral portion, at which the pressing force is comparatively high during mold pressing, is heated to a comparatively low temperature, and the interior/intermediate portion, at which the pressing force is comparatively low during mold pressing, is heated to a comparatively high temperature. That is, the mold 12 and transfer substrate 20 are heated at an appropriate temperature distribution corresponding to the pressing force distribution during mold pressing, so that the fine concavity and convexity pattern of the mold 12 can be transferred uniformly to the transfer layer 22 on the substrate 21.

The outer shape of the heating mechanisms 30 is not limited to a circular shape, but may be a polygon shape, as shown in (b) of FIG. 4, according to the outer shape of the transfer substrate 20 and mold 12. In this case also, the heating mechanisms 30 have heating regions divided into an interior/intermediate portion and a peripheral portion, and the arrangement of the heat-generating elements are adjusted for each divided region so as to have a temperature distribution according to the pressing force distribution. The arrangement of each of the heat-generating elements divided in the heating member interior is not limited to that described above, but may be modified appropriately according to the mold pressing force distribution, based on the mold construction and other factors.

Next, an imprinting method using the above-described thermal imprinting device is explained. First, a mold 12 is prepared having the desired concavity and convexity pattern formed in the surface, and the surface is treated using a silane coupling agent or similar to treat the concavity and convexity pattern formation face of the mold 12, in order to prevent adhesion of the transfer layer material or similar and to improve separation properties. Then, the mold 12 is mounted on the mold holding face of the mold holding portion 11, to hold the mold 12.

Next, a transfer substrate 20 is prepared. The transfer substrate 20 employs a flat substrate 21 comprising for example a silicon substrate, glass substrate, aluminum substrate, or similar, onto which is applied PMMA or another thermoplastic resin using for example spin coating, to form a transfer layer 22. After forming the transfer layer 22 on the substrate 21, the transfer substrate 20 is mounted on the transfer substrate holding face of the transfer substrate holding portion 13, to hold the transfer substrate 20.

The transfer substrate holding portion 13 and a heating mechanism 30 connected to the transfer substrate holding portion 13 are provided so as to enable raising and lowering, and are driven by a pressing device, not shown, in the directions approaching and receding from the mold holding portion 11 (the upward and downward directions in FIG. 3), performing operations to press the transfer layer 22 on the substrate 21 against the mold 12 and to separate the two. In the state in which the transfer layer 22 on the substrate 21 is in contact with the mold 12, the transfer substrate holding portion 13 is further pressed toward the mold holding portion 11, and by this means the concavity and convexity pattern formation face of the mold 12 is pressed against the transfer layer 22 on the substrate 21. In this embodiment, the transfer substrate holding portion 13 and the heating mechanism 30 which is connected to the transfer substrate holding portion 13 are driven; but configuration is not limited to this, and the transfer substrate holding portion 13 and the heating mechanism 30 connected to the transfer substrate holding portion 13 may be held fixed while the mold holding portion 11 and the heating mechanism 30 connected to the mold holding portion 11 are driven, or the transfer substrate holding portion 13 and the heating mechanism 30 connected to the transfer substrate holding portion 13, and the mold holding portion 11 and the heating mechanism 30 connected to the mold holding portion 11, may both be relatively driven.

Next, after adjusting the relative positions of the mold 12 and transfer substrate 20, the heat-generating elements 32a and 32b of the heating mechanisms 30 are caused to generate heat, and the transfer substrate 20 and mold 12 are heated to the softening temperature of the transfer layer 22 or above. At this time, due to the configuration of the heating mechanisms 30, the interior/intermediate portion of the transfer substrate 20 is heated to a high temperature compared with the peripheral portion. As the softening temperature, in the case of a polymer material, the glass transition temperature (Tg) is used. However, for crystalline polymers there are cases in which softening does not occur even when Tg is exceeded, and a temperature close to the crystal melting temperature is used. The thermal deformation temperature (Td), defined as the temperature at which constant deformation occurs when a constant load is applied, may also serve as the softening temperature.

After the transfer substrate 20 and mold 12 have reached the desired temperature, the transfer substrate holding portion 13 is moved to the side of the mold holding portion 11 by a pressing mechanism (not shown), as described above, and the transfer layer 22 is brought into close contact with the concavity and convexity pattern formation face of the mold 12. After the transfer layer 22 and the mold 12 are in close contact, the pressing mechanism applies pressure necessary for pattern transfer, and holds this state. Because the transfer layer 22 is in a softened state due to heating, the transfer layer 22 is deformed along the fine concavity and convexity pattern shape of the mold. The mold 12 itself is also heated to the softening temperature of the transfer layer 22, so that softening of the transfer layer 22 is promoted. The pressure and holding time for pressing the mold 12 against the transfer layer 22 is set appropriately according to the concavity and convexity pattern shape of the mold 12, the material of the transfer layer 22, and other parameters.

Next, the mold 12 and transfer substrate 20 are cooled by cooling means, not shown, to cause the transfer layer 22 to harden. Here, cooling means lowering the temperature to a temperature at which the resin forming the transfer layer 22 hardens, and includes, in addition to cases in which cooling means are used for active cooling, the use of natural cooling to lower the temperature, as well as cases in which the temperature is lowered while continuing heating by the heating means. By this means, a fine concavity and convexity pattern is finalized in the surface of the transfer layer 22; thereafter, when the mold 12 is separated from the transfer substrate 20, the fine concavity and convexity pattern formed in the mold 12 is transferred to the transfer layer 22 on the substrate 21. At this time, remaining film of the transfer layer 22 on the substrate 21 remains in the portions equivalent to protrusions in the mold 12, and so by using oxygen reactive ion etching (RIE) or another method this remaining film is removed, exposing the surface of the substrate 21. Through the above processes, the fine concavity and convexity pattern of the mold 12 can be formed uniformly and accurately over the entire face of the transfer substrate 21 using an imprinting process.

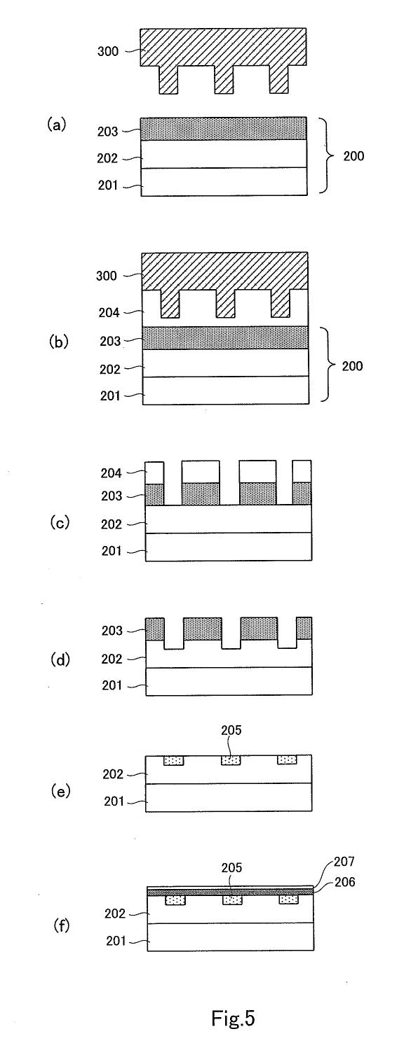

The above imprinting process can be applied to processes to manufacture patterned media and other magnetic recording media. Below, processes to manufacture discrete track media, which is one kind of patterned media, comprising the above-described imprinting process, are explained referring to the manufacturing process diagrams shown in FIG. 5.

First, a mold 300 is fabricated, having the desired concavity and convexity pattern on the surface of a base material, of silicon, glass, or similar. The concavity and convexity pattern is formed in the surface of the mold 300 by using electron beam lithography or another method to form a resist pattern, and then using the resist pattern as a mask to perform dry etching or similar. The completed mold 300 is surface-treated with a silane coupling agent or similar to improve separation properties. The mold 300 may also be used as a master to fabricate a nickel (or nickel alloy) or other transfer mold, replicated using an electrocasting or other method.

Next, a discrete track media substrate (hereafter “media substrate”) 200 is fabricated. The media substrate 200 can be formed by depositing a recording layer 202 and a metal mask layer 203 on substrate material 201, comprising specially treated chemically reinforced glass, a silicon wafer, an aluminum substrate, or similar. The recording layer 202 is formed by layering in order a soft magnetic underlayer, intermediate layer, and ferromagnetic layer by sputtering; the metal mask layer 203 is formed by using sputtering to deposit for example Ta, Ti, or similar ((a) in FIG. 5).

Next, the above-described imprinting method is used to transfer the concavity and convexity pattern formed on the mold 300 onto the transfer layer 204 formed on the media substrate 200. That is, spin coating or another method is used to form a transfer layer 204 of a thermoplastic material on the media substrate 200 prepared in the above process, the mold 300 is held on the mold holding portion 11, and the media substrate 200 is held on the transfer substrate holding portion 13, after which the relative positions of the media substrate 200 and mold 300 are adjusted. When positioning is completed, the heat-generating elements 32a and 32b of the heating mechanisms 30 are caused to generate heat, heating the media substrate 200 and mold 300. When the desired temperature for softening the transfer layer 204 is reached, the mold 300 and transfer layer 204 are brought into close contact, and pressing is performed to perform transfer. Then, the media substrate 200 and mold 300 are cooled, and after the transfer layer 204 has hardened the mold 300 is separated from the media substrate 200, and the media substrate 200 is removed from the transfer substrate holding portion 13. Through the above processes, the concavity and convexity pattern of the mold 300 is transferred to the transfer layer 204 formed on the media substrate 200 ((b) in FIG. 5).

Next, because remaining film of the transfer layer 204 remains in portions equivalent to protrusions of the mold 300, oxygen reactive ion etching (RIE) is performed to remove the remaining film. Next, the transfer layer 204 which has been patterned in the above imprinting process is used as a mask in performing dry etching to etch the metal mask layer 203 and perform patterning ((c) of FIG. 5).

Next, after using wet etching or dry etching to remove the transfer layer 204 remaining on the media substrate 200, the metal mask layer 203 is used as a mask in dry etching to etch the recording film layer 202, to form grooves in the recording film layer 202 ((d) of FIG. 5).

Next, the remaining metal mask layer 203 is removed by wet etching or by dry etching, after which a nonmagnetic material 205 is applied to as to fill the grooves, and etching, chemical polishing, and similar are performed to flatten the surface ((e) of FIG. 5).

Next, a CVD method or a sputtering method is used to form a surface protective layer 206, comprising diamond-like carbon (DLC) or similar with excellent lubricating properties and wear-resistant properties, and a lubricant comprising perfluoro polyethyer (PFPE) diluted by a solvent or similar is applied by a dipping method or a spin-coating method, to form a lubricating layer 207 ((f) in FIG. 5).

By means of the above processes, discrete track media to which an imprinting method of this invention has been applied is completed.

As is clear from the above explanation, in a thermal imprinting device of the first embodiment of the invention, heating regions are divided in the circumferential direction in the heating mechanisms which heat the mold and the transfer substrate, and the arrangement of heat-generating elements within the heating mechanism is made different for each divided heating region according to the pressure distribution during mold pressing, so that a temperature distribution is formed so as to correct the non-uniform pressure distribution during mold pressing. By this means, the mold and transfer substrate are heated at a temperature distribution so as to correct the edge effect occurring during mold pressing, so that the fine concavity and convexity pattern of the mold can be transferred, uniformly and accurately, to the transfer layer of the transfer substrate. Further, in a thermal imprinting device of this invention, accommodation is possible merely by altering the arrangement of heat-generating elements in each of the divided heating regions, so that there is no need to perform temperature adjustment for each divided heat-generating element, and simple alteration or modification of the existing device alone is sufficient. Moreover, in a thermal imprinting device of this invention, there is no need for an adjustment operation or for preparation of elastic members or other components to render the mold pressing force uniform as in the above-described prior art, so that the number of components of the device can be reduced.

The configuration of each of the portions of the imprinting device of the above-described first embodiment is not limited to the above descriptions, and various alternations are possible. In the following, modified examples of imprinting devices of this embodiment are described.

### Modified Example 1

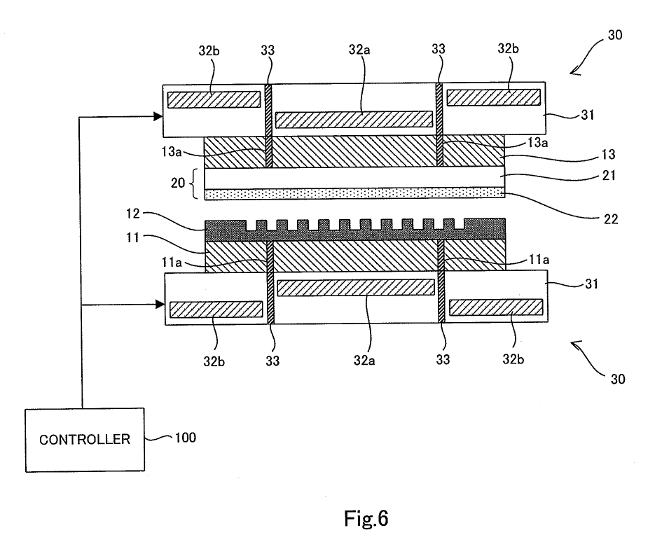

FIG. 6 is a cross-sectional view showing the configuration of a first modified example of the thermal imprinting device of the first embodiment of the invention. In the thermal imprinting device of this embodiment, in addition to the above-described thermal imprinting device configuration, adiabatic members 11a and 13a are provided which partition the interior of the mold holding portion 11 and the transfer substrate holding portion 13 as well into an interior/intermediate portion and a peripheral portion. By means of these adiabatic members 11a and 13a, the mold holding portion 11 and transfer substrate holding portion 13 are also thermally divided into interior/intermediate portions and peripheral portions. That is, heated regions are formed in the mold holding portion 11 and in the transfer substrate holding portion 13 corresponding to the heating regions of the heating mechanisms 30, and these heated regions are partitioned by the adiabatic members 11a and 13a. By this means, the temperature distribution brought about by the heating mechanisms 30 is conveyed to the mold 12 and the transfer substrate 20 without mutual interference within the mold holding portion 11 or the transfer substrate holding portion 13, and more accurate temperature control can be performed.

### Modified Example 2

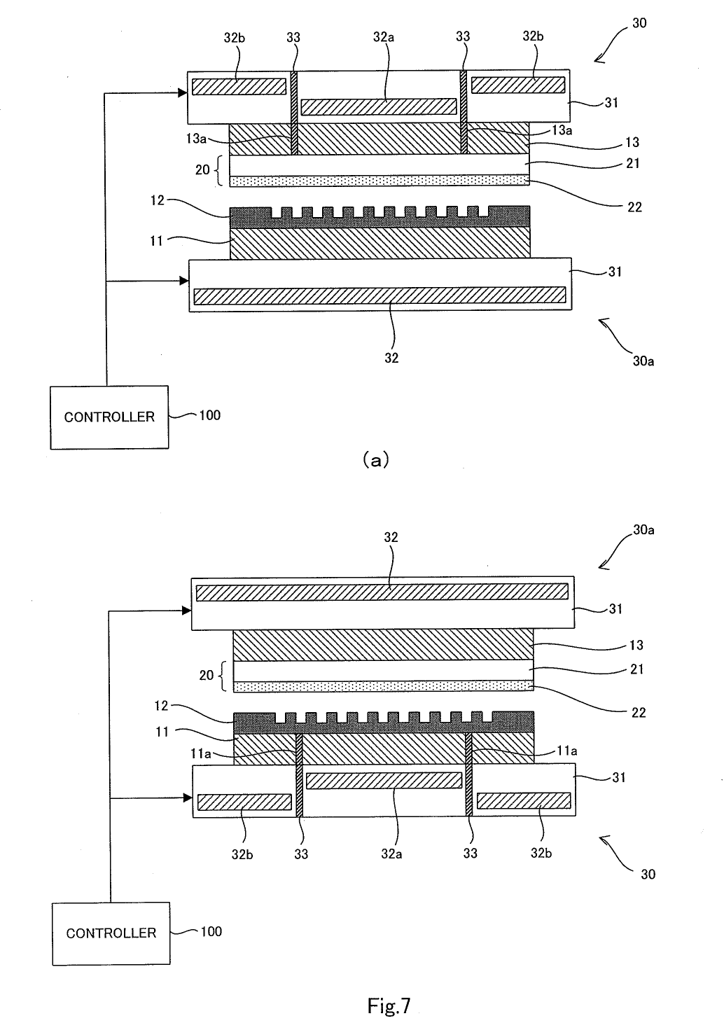

FIG. 7 is a cross-sectional view showing the configuration of a second modified example of the thermal imprinting device of the first embodiment of the invention. In the thermal imprinting device of this embodiment, as shown in (a) of FIG. 7, the heating mechanism 30a abutting the mold holding portion 11 has only a single heat-generating element 32, and is arranged so as to be parallel with the heating face, with no adiabatic member provided. That is, there is no division into heating regions in the heating mechanism 30a, and the temperature distribution at the face abutting the mold holding portion 11 (the heating face) is uniform. On the other hand, the heating mechanism 30 abutting the side of the transfer substrate holding portion 13 has a configuration similar to that of the heating mechanisms already described; the heat-generating element 32b provided in the region corresponding to the peripheral portion of the transfer substrate is arranged at a position removed from the transfer substrate 20 compared with the heat-generating element 32a provided in the region corresponding to the interior/intermediate portion, and by this means a heating face with an appropriate temperature distribution is formed according to the pressing force distribution during mold pressing. That is, only the heating mechanism on the side of the transfer substrate forms a temperature distribution according to the pressing force distribution during mold pressing, and the mold-side heating mechanism is configured such that the temperature distribution is uniform. In this configuration, the heat-generating element need be divided, and positions set, in only one among the pair of heating mechanisms, so that simple alteration (modification) of an existing device is sufficient. In this embodiment, as shown in (b) of FIG. 7, a configuration may also be employed in which the heating mechanisms 30 and 30a are interchanged.

### Modified Example 3

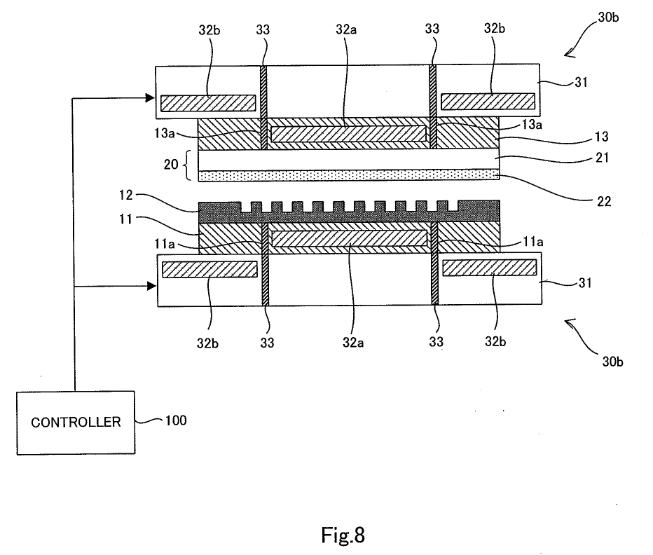

FIG. 8 is a cross-sectional view showing the configuration of a third modified example of the thermal imprinting device of the first embodiment of the invention. In the thermal imprinting device of this embodiment, heat-generating elements 32a are provided within the mold holding portion 11 and the transfer substrate holding portion 13 in the regions corresponding to the interior/intermediate portions of the mold 12 and transfer substrate 20. And, adiabatic members 11a and 13a are provided in the mold holding portion 11 and transfer substrate holding portion 13, such that heat generated from the heat-generating elements 32a does not diffuse to the peripheral portions. On the other hand, a heat-generating elements 32b are provided only in the regions corresponding to the peripheral portions of the mold 12 and transfer substrate 20 in the heating members 31 of the heating mechanisms 30b abutting the faces of the mold holding portion 11 and transfer substrate holding portion 13 on the sides opposite the holding faces, and adiabatic members 33 are provided such that heat generated from the heat-generating elements 32b does not diffuse to the interior portion. That is, in this embodiment only heat-generating elements which heat the interior/intermediate portions of the mold 12 and transfer substrate 20 are arranged within the mold holding portion 11 and transfer substrate holding portion 13, so that the arrangement of heat-generating elements is made different for each heating region. Through this arrangement of heat-generating elements, the mold 12 and transfer substrate 20 can be heated at a temperature distribution according to the pressing force distribution during mold pressing.

### Modified Example 4

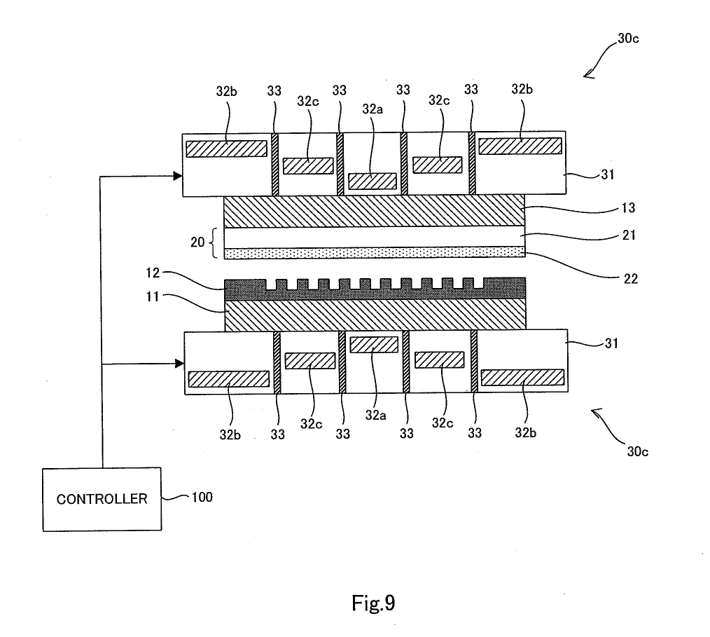

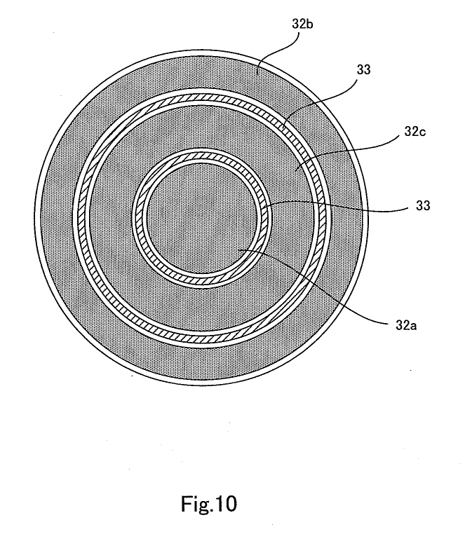

FIG. 9 is a cross-sectional view showing the configuration of a fourth modified example of the thermal imprinting device of the first embodiment of the invention, and FIG. 10 is a top view of a heating mechanism 30c of this embodiment. The heating region of a heating mechanism 30c in this embodiment is divided into three regions. That is, the heat-generating element 32a has a circular shape, and heats the interior portions of the mold 12 and the transfer substrate 20. The heat-generating element 32c has a circular ring shape, is arranged so as to surround the periphery of the heat-generating element 32a, and heats the intermediate portion of the mold 12 and the transfer substrate 20. The heat-generating element 32b has a circular ring shape, is arranged so as to surround the periphery of the heat-generating element 32c, and heats the peripheral portions of the mold 12 and the transfer substrate 20. Adiabatic members 33 are provided between the heat-generating elements 32a and 32c and between the heat-generating elements 32c and 32b, so that there is no mutual interference of the heat generated in each region. In the interior of these heating members 31, the heat-generating elements divided in this way are arranged at positions successively removed from the mold 12 and the transfer substrate in the order of heat-generating elements 32a, 32c, 32b. By this means, the surface temperature at the heating faces of the heating mechanisms 30c (that is, the faces of the heating mechanisms 30c abutting the mold holding portion 11 and the transfer substrate holding portion 13) assumes a temperature distribution which rises gradually in the order of the peripheral portion, intermediate portion, and interior portion.

By means of this configuration, the heating regions forming a temperature distribution are more finely divided, and the range of adjustment of the temperature distribution can be broadened. And, when for example using a mold having a hole in the center portion to perform imprinting, an edge exists in the interior portion also, and there occur regions in the mold interior portion and peripheral portion in which the pressing force is higher; in this case also, an appropriate temperature distribution can be formed according to the pressing force distribution. The heating region can be divided still more finely, and in addition to the above configuration, the arrangement of heat-generating elements within the heating members may be altered appropriately according to the mold pressing force distribution, based on the mold shape and other parameters.

### Modified Example 5

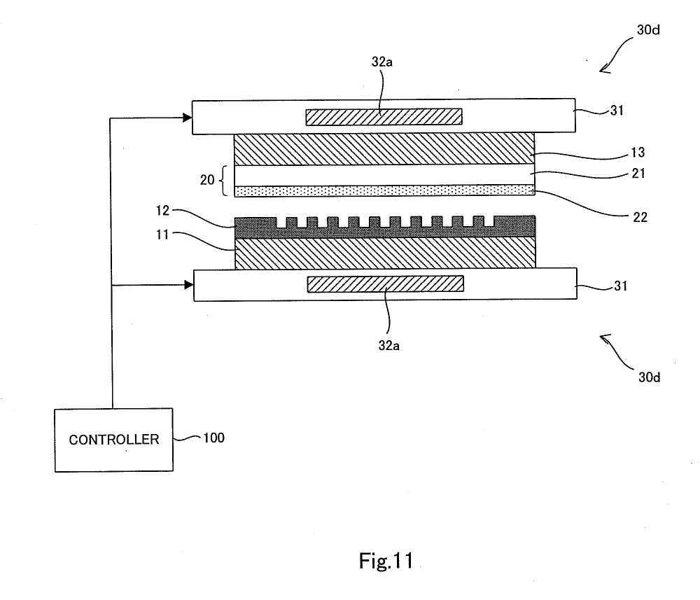

FIG. 11 is a cross-sectional view showing the configuration of a fifth modified example of the thermal imprinting device of the first embodiment of the invention. In the heating mechanisms 30d of the thermal imprinting device of this embodiment, heat-generating elements 32a are provided only in the regions corresponding to the interior/intermediate portions of the mold 12 and the transfer substrate 20, and heat-generating elements are not provided in regions corresponding to peripheral portions. Heat supplied from the heat-generating elements 32a is conducted, via the mold holding portion 11 and transfer substrate holding portion 13, to the peripheral portions of the mold 12 and transfer substrate 20, which are heated to a temperature lower than that of the interior/intermediate portions. By means of this configuration, a temperature distribution corresponding to the pressing force distribution during mold pressing can be formed. By means of this embodiment the heating mechanisms can have an extremely simple configuration, and an existing device can be utilized without modification.

In a thermal imprinting device of the first embodiment of the invention, the configurations of the various modified examples may be combined appropriately.

### Second Embodiment

Next, the thermal printing device of a second embodiment of the invention is explained. Similarly to the above-described first embodiment, a thermal imprinting device of the second embodiment of the invention has heating mechanisms which heat a mold and a transfer substrate; the heating mechanisms have heat sources which are divided into a region corresponding to the interior/intermediate portions of the mold and transfer substrate, and a region corresponding to the peripheral portions of the mold and transfer substrate. And, by making the temperature settings of these heat sources different for each of the regions according to the pressing force distribution during mold pressing, a temperature distribution can be formed so as to correct the non-uniform pressing force distribution during mold pressing.

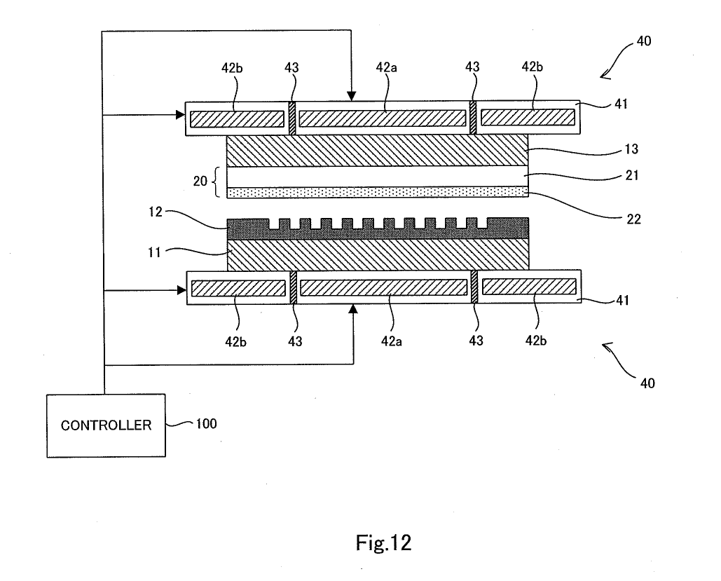

FIG. 12 is a cross-sectional view showing the configuration of the thermal imprinting device of a second embodiment of the invention. The thermal imprinting device of this embodiment differs from the first embodiment above only in the configuration of the heating mechanisms. The heating mechanisms 40 abut the faces of the mold holding portion 11 and transfer substrate holding portion 13 on the sides opposite the holding faces, and heat the mold 12 and the transfer substrate 20 via the mold holding portion 11 and the transfer substrate holding portion 13. The transfer layer 22 formed on the substrate 21 is softened by heat supplied from the heating mechanisms 40, enabling pattern transfer.

The heating mechanisms 40 comprise heat-generating elements 42a and 42b, comprising electrical heaters, lamp heaters, thermostatic devices using liquid or gas heat sources, or similar; heating members 41, comprising a material with comparatively high thermal conductivity such as a metal or similar, and having the heat-generating elements 42a and 42b; adiabatic members 43, provided between the heat-generating elements 42a and 42b; and, a temperature controller 100 which individually controls the heat-generating temperatures of the heat-generating elements 42a and 42b.

The outer shape of the heating mechanisms 40 can be made any shape, according to the outer shapes of the transfer substrate 20 and mold 12, and can for example have a disc shape similarly to the first embodiment, as shown in (a) of FIG. 4. That is, by making the shape of the heating mechanisms 40 a shape similar to that of the transfer substrate 20 and mold 12, a temperature distribution corresponding to the above-described edge effect can be formed. In this case, it is desirable that the mold holding portion 11 and the transfer substrate holding portion 13 also have disc shapes.

As shown in FIG. 12 and in (a) of FIG. 4, the heat-generating elements 42a are circular, extending the regions corresponding to the interior/intermediate portions of the transfer substrate 20 and mold 12, and heating the interior/intermediate portions of the transfer substrate 20 and mold 12. On the other hand, the heat-generating elements 42b have a ring shape, arranged so as to surround the periphery of the heat-generating elements 42a, extend the regions corresponding to the peripheral portions of the transfer substrate 20 and mold 12, and heat the peripheral portions of the transfer substrate 20 and mold 12. An adiabatic member 43 is provided between the heat-generating elements 42a and 42b, so that there is no mutual interference of heat generated in each region. That is, a heating mechanism 40 forms two heating regions by means of heat-generating elements divided into an interior/intermediate portion and a peripheral portion, and an adiabatic member provided therebetween. Temperature control is executed independently for each of the heat-generating elements 42a and 42b by the temperature controller 100, so that for example the temperature settings of the heat-generating elements 42a are set to higher temperatures than for the heat-generating elements 42b. By means of this configuration of the heating mechanisms 40, the surface temperature at the heating face of a heating mechanism 40 (that is, the face of the heating mechanism 40 abutting the mold holding portion 11 and transfer substrate holding portion 13) assumes a temperature distribution which is higher in the interior/intermediate portion than in the peripheral portion. That is, the heating ability of the heating mechanism 40 is different in each of the heating regions.

Through this temperature distribution on the heating faces of the heating mechanisms 40, the peripheral portion, at which the pressing force is comparatively high during mold pressing, is heated to a comparatively low temperature, and the interior/intermediate portion, at which the pressing force is comparatively low during mold pressing, is heated to a comparatively high temperature. That is, the mold 12 and transfer substrate 20 are heated at an appropriate temperature distribution corresponding to the pressing force distribution during mold pressing, so that the fine concavity and convexity pattern of the mold 12 can be transferred uniformly to the transfer layer 22 on the substrate 21.

The outer shape of the heating mechanisms 40 is not limited to a circular shape, but may be a polygon shape, as shown in (b) of FIG. 4, according to the outer shape of the transfer substrate 20 and mold 12. In this case also, the heating mechanisms 40 have heating regions divided into an interior/intermediate portion and a peripheral portion so as to have a temperature distribution according to the pressing force distribution. The temperature settings and temperature distribution of the divided heating members in each heating region may be set appropriately according to the mold construction and similar. Constituent components other than the heating mechanisms 40 are similar to those in the above-described first embodiment, and explanations are omitted.

Thus in a thermal imprinting device of the second embodiment of this invention, heating regions are divided in the circumferential direction in the heating mechanisms which heat the mold and the transfer substrate, and the heating temperatures of divided heat sources are made different for each heating region according to the pressure distribution during mold pressing, so that a temperature distribution is formed so as to correct the non-uniform pressure distribution during mold pressing. By this means, the mold and transfer substrate are heated at a temperature distribution so as to correct the edge effect occurring during mold pressing, so that the fine concavity and convexity pattern of the mold can be transferred, uniformly and accurately, to the transfer layer of the transfer substrate.

Moreover, in a thermal imprinting device of this invention, there is no need for an adjustment operation to render the mold pressing force uniform as in the above-described prior art, nor is there a need to prepare insertion shims, elastic elements, or similar, so that the number of components of the device can be reduced.

The configuration of each of the portions of the imprinting device of the above-described second embodiment is not limited to the above descriptions, and various alternations are possible. In the following, modified examples of imprinting devices of this embodiment are described.

### Modified Example 1

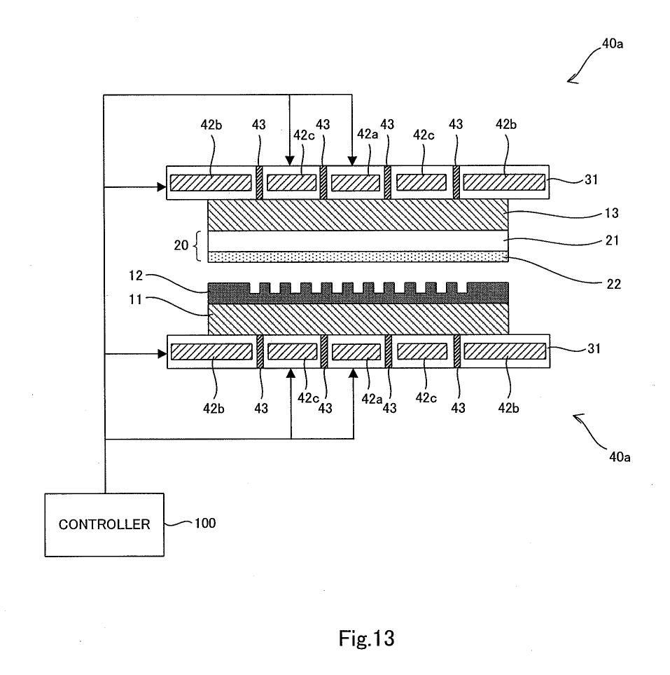

FIG. 13 is a cross-sectional view showing the configuration of a first modified example of the thermal imprinting device of the second embodiment of the invention. In the thermal imprinting device of this embodiment, the configuration of the heating mechanisms differs from that described above. Heating region for the heating mechanism 40a related to this embodiment is divided into three regions. A top view of a heating mechanism 40a is similar to that shown in FIG. 10 for the above-described first embodiment. That is, a heat-generating element 42a is circular, extending the regions corresponding to the interior portions of the transfer substrate 20 and mold 12, and heating the interior portions of mold 12 and the transfer substrate 20. On the other hand, the heat-generating elements 42c have a ring shape, arranged so as to surround the periphery of the heat-generating elements 42a, and extend the regions corresponding to the intermediate portions of the transfer substrate 20 and mold 12, and heating the intermediate portions of the mold 12 and the transfer substrate 20. The heat-generating elements 42b have a ring shape, arranged so as to surround the periphery of the heat-generating elements 42c, and extend the regions corresponding to the peripheral portions of the transfer substrate 20 and mold 12, and heating the peripheral portions of the mold 12 and transfer substrate 20. Adiabatic members 43 is provided between the heat-generating elements 42a and 42c and between the heat-generating elements 42c and 42b, so that there is no mutual interference of heat generated in each region. Temperature control of the heat-generating elements 42a, 42b, 42c is performed independently for the respective elements by the temperature controller 100. The temperature settings for the heat-generating elements are set by this temperature controller 100 such that the heat-generating temperatures rise in order, for example, for the heat-generating elements 42b, 42c, 42a, so as to correct the non-uniform pressure distribution during mold pressing.

By means of this configuration, the heating regions forming a temperature distribution are more finely divided, and the range of adjustment of the temperature distribution can be broadened. And, when for example using a mold having a hole in the center portion to perform imprinting, an edge exists in the interior portion also, and there occur regions in the mold interior portion and peripheral portion in which the pressing force is higher; in this case also, an appropriate temperature distribution can be formed according to the pressing force distribution.

### Modified Example 2

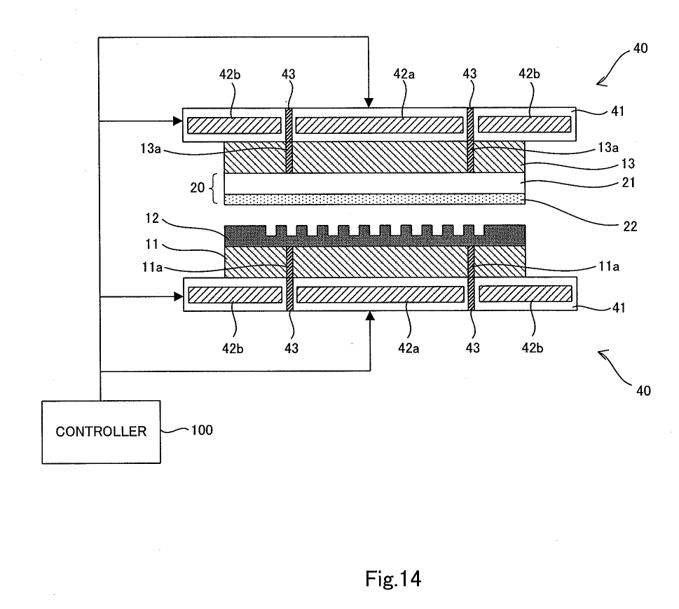

FIG. 14 is a cross-sectional view showing the configuration of a second modified example of the thermal imprinting device of the second embodiment of the invention. In the thermal imprinting device of this embodiment, adiabatic members 11a and 13a which partition the interior/intermediate portions and the peripheral portions are also provided in the mold holding portion 11 and in the transfer substrate holding portion 13. That is, by means of these adiabatic members 11a and 13a, the interior/intermediate portions and peripheral portions in the mold holding portion 11 and transfer substrate holding portion 13 are also thermally separated. In other words, heated regions are formed in the mold holding portion 11 and in the transfer substrate holding portion 13 corresponding to the heating regions of the heating mechanisms 40, and these heated regions are partitioned by the adiabatic members 11a and 13a. By this means, the temperature distributions induced by the heating mechanisms 40 do not mutually interfere within the mold holding portion 11 or the transfer substrate holding portion 13, but are conveyed to the mold 12 and to the transfer substrate 20, so that more accurate temperature control becomes possible.

### Modified Example 3

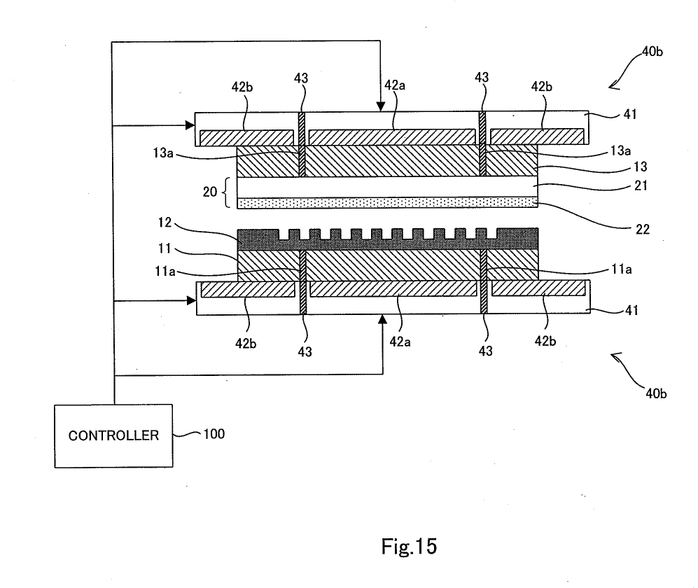

FIG. 15 is a cross-sectional view showing the configuration of a third modified example of the thermal imprinting device of the second embodiment of the invention. The basic configuration of the thermal imprinting device of this embodiment is substantially the same as in the second modified example above, but the arrangement of heat-generating elements within the heating mechanisms 40b is different from that described above. That is, the heat-generating elements 42a and 42b are arranged close to the faces in the heating members 41b abutting the mold holding portion 11 and the transfer substrate holding portion 13. By arranging the heat-generating elements 42a and 42b in these positions, the distance of movement of heat supplied from the heat-generating elements to the mold 11 and to the transfer substrate 20 is shortened, and so the time until the preset temperatures are reached can be reduced. By shortening the distance from the heat sources, external factors which may disturb temperature control can be eliminated, and temperature control by the heating mechanisms can be performed more accurately.

### Modified Example 4

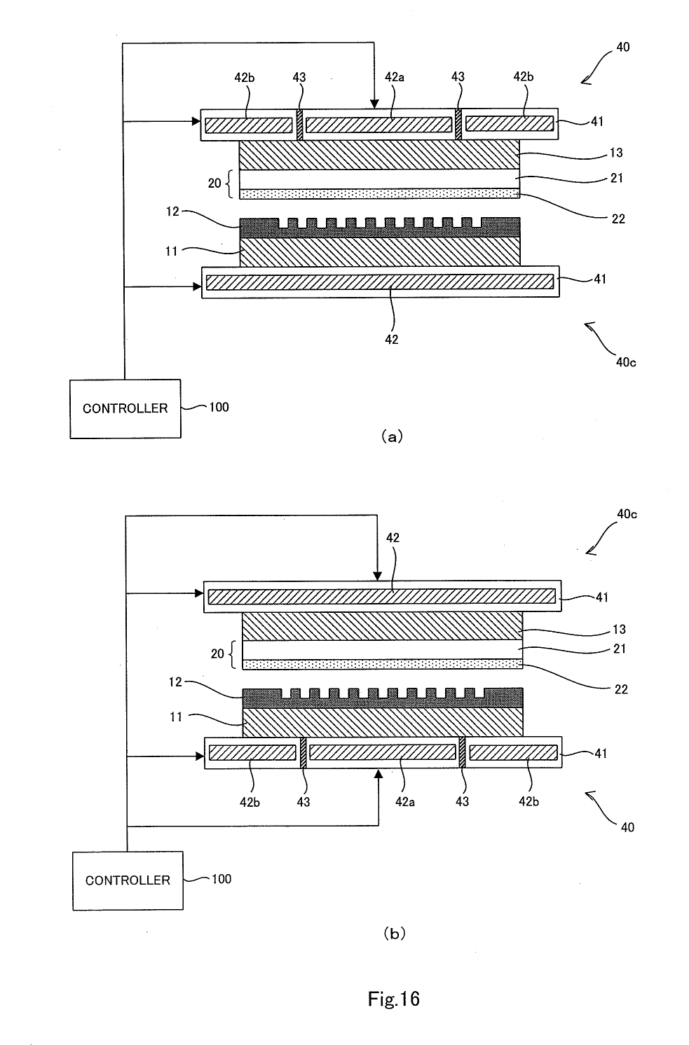

FIG. 16 is a cross-sectional view showing the configuration of a fourth modified example of the thermal imprinting device of the second embodiment of the invention. In the thermal imprinting device of this embodiment, as shown in (a) of FIG. 16, a single heat-generating element 42 is provided in the heating mechanism 40c abutting the mold holding portion 11. That is, the heating region of the heating mechanism 40c is not divided, and a uniform temperature distribution is formed in the face abutting the mold holding portion 11. On the other hand, by having the temperature controller 100 perform separate and independent temperature control of the divided heat-generating elements 42a and 42b in the heating mechanism 40 abutting the transfer substrate holding portion 13, a temperature distribution is formed according to the pressing force distribution during mold pressing. That is, a temperature distribution is formed according to the pressing force distribution during mold pressing only by the heating mechanism 40 on the side of the transfer substrate; the heating mechanism 40c on the mold side forms a uniform temperature distribution. By means of this configuration, among the pair of heating mechanisms, the heat-generating elements need be divided in only one, so that an existing device can easily be altered (modified). In this embodiment, as shown in (b) of FIG. 16, the heating mechanisms 40 and 40c may be interchanged.

### Modified Example 5

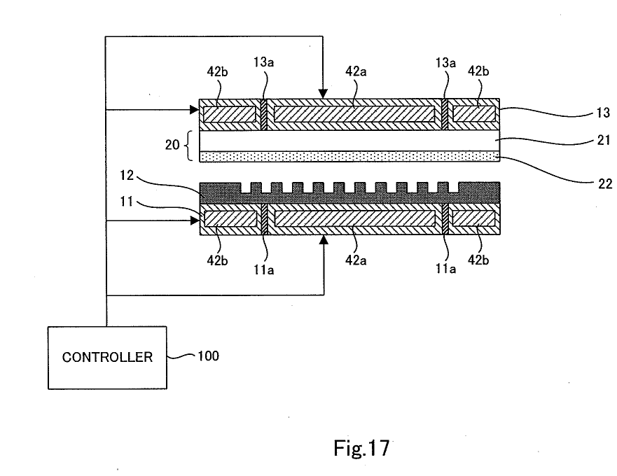

FIG. 17 is a cross-sectional view showing the configuration of a fifth modified example of the thermal imprinting device of the second embodiment of the invention. In the thermal imprinting device of this embodiment, the heat-generating elements 42a and 42b are provided within the mold holding portion 11 and the transfer substrate holding portion 13. The heat-generating elements 42a are provided in regions corresponding to the interior/intermediate portions of the mold 12 and transfer substrate 20, and the heat-generating elements 42b are provided in regions corresponding to the peripheral portions of the mold 12 and transfer substrate 20. Adiabatic members 11a and 13a are provided between the heat-generating elements 42a and 42b, so that there is no mutual interference of heat generated in each region. Separate and independent temperature control of the heat-generating elements 42a and 42b is performed by the temperature controller 100, and the temperature setting of the heat-generating elements 42a is set to a higher temperature than the heat-generating elements 42b. By means of this configuration, a temperature distribution corresponding to the pressing force distribution during mold pressing can be formed.

In this way, by also providing heating mechanism functions in the mold holding portion 11 and in the transfer substrate holding portion 13, device compactness and simplification become possible, and device adjustment and maintenance tasks are also facilitated. Further, the distance of movement of heat supplied from the heat-generating elements 42a and 42b to the mold 11 and transfer substrate 20 is shortened, and so the time required to reach the preset temperature can be reduced. By shortening the distance from the heat sources, external factors which may disturb temperature control can be eliminated, and temperature control by the heating mechanisms can be performed more accurately.

### Modified Example 6

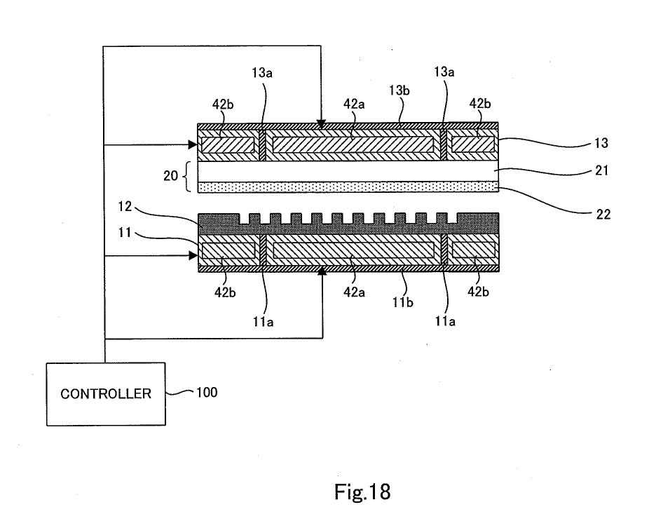

FIG. 18 is a cross-sectional view showing the configuration of a sixth modified example of the thermal imprinting device of the second embodiment of the invention. In the thermal imprinting device of this embodiment, similarly to the above fifth modified example, the heat-generating elements 42a and 42b are provided within the mold holding portion 11 and transfer substrate holding portion 13. Further, adiabatic members 11a and 13a are provided between the heat-generating elements 42a and 42b, so that there is no mutual interference of heat generated in each of the regions. Further, adiabatic members 11b and 13b are provided, adjacent to and extending the faces of the mold holding portion 11 and transfer substrate holding portion 13 on the sides opposite the holding faces.

By means of this configuration, the adiabatic properties of the mold holding portion 11 and transfer substrate holding portion 13 can be improved. That is, when the pressing mechanisms (not shown) and other components are brought into contact with the faces of the mold holding portion 11 and transfer substrate holding portion 13 on the sides opposite the holding faces, disturbance of the temperature distributions of the holding faces (heating faces) due to heat dissipation and similar can be prevented. Hence the temperature distributions induced by the heat-generating elements 42a and 42b can be reliably conveyed to the mold 12 and to the transfer substrate 20.

In a thermal imprinting device of the second embodiment of the invention, the configurations of the various modified examples may be combined appropriately.

### Third Embodiment

Next, the thermal printing device of a third embodiment of the invention is explained. Similarly to the above-described first and second embodiments, a thermal imprinting device of the third embodiment of the invention has heating mechanisms which heat a mold and a transfer substrate; the heating mechanisms have heat sources which are divided into a region corresponding to the interior/intermediate portions of the mold and transfer substrate, and a region corresponding to the peripheral portions of the mold and transfer substrate. And, by making the constituent materials of these heating members having the heat sources different for each of the regions according to the pressing force distribution during mold pressing, a temperature distribution can be formed at the heating faces of the heating mechanisms so as to correct the non-uniform pressing force distribution during mold pressing.

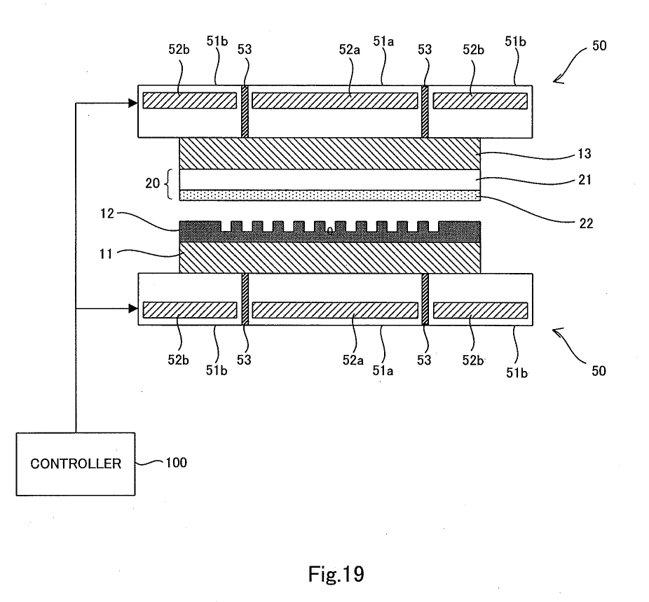

FIG. 19 is a cross-sectional view showing the configuration of the thermal imprinting device of the third embodiment of the invention. The heating mechanisms 50 of the thermal imprinting device of this embodiment abut the faces of the mold holding portion 11 and transfer substrate holding portion 13 on the sides opposite the holding faces, and heat the mold 12 and the transfer substrate 20 via the mold holding portion 11 and the transfer substrate holding portion 13. The transfer layer 22 formed on the substrate 21 is softened by heat supplied from the heating mechanisms 40, enabling pattern transfer.

The heating mechanisms 50 comprise heat-generating elements 52a and 52b, comprising electrical heaters, thermostatic devices using liquid or gas heat sources, or similar; heating members 51a and 51b, comprising a material with comparatively high thermal conductivity such as a metal or similar, and having the respective heat-generating elements 52a and 52b; adiabatic members 53 provided between the heat-generating elements 52a and 52b; and, a temperature controller 100 which controls the heat-generating temperatures of the heat-generating elements 52a and 52b.

The outer shape of the heating mechanisms 50 can be made any shape, according to the outer shapes of the transfer substrate 20 and mold 12, and can for example have a disc shape similarly to the first embodiment, as shown in (a) of FIG. 4. That is, by making the shape of the heating mechanisms 50 a shape similar to that of the transfer substrate 20 and mold 12, a temperature distribution corresponding to the above-described edge effect can be formed. In this case, it is desirable that the mold holding portion 11 and the transfer substrate holding portion 13 also have disc shapes.

As shown in FIG. 19 and in (a) of FIG. 4, the heat-generating elements 52a are circular, extending the regions corresponding to the interior/intermediate portions of the transfer substrate 20 and mold 12, and heating the interior/intermediate portions of the transfer substrate 20 and mold 12. On the other hand, the heat-generating elements 52b have a ring shape, arranged so as to surround the periphery of the heat-generating elements 52a, extend the regions corresponding to the peripheral portions of the transfer substrate 20 and mold 12, and heat the peripheral portions of the transfer substrate 20 and mold 12. An adiabatic member 53 is provided between the heat-generating elements 52a and 52b, so that there is no mutual interference of heat generated in each region. That is, a heating mechanism 50 forms two heating regions by means of heat-generating elements divided into an interior/intermediate portion and a peripheral portion, and an adiabatic member provided therebetween. The heating members 51a, having heat-generating elements 52a, comprise for example copper with comparatively high thermal conductivity, and the heating members 51b, having heat-generating elements 52b, comprise for example iron or similar, having thermal conductivity lower than that of copper. The temperature controller 100 executes control of the heat-generating elements 52a and 52b such that the same heating temperature results. By means of this configuration of the heating mechanisms 50, a temperature distribution results at the heating face of the heating mechanisms 50 (that is, at the faces at which the heating mechanisms 50 abut the mold holding portion 11 and the transfer substrate holding portion 13) in which the temperature is higher in the interior/intermediate portion than in the peripheral portion. That is, the heating capacities of the heating mechanisms 50 are different in each of the heating regions.

Through this temperature distribution at the heating faces of the heating mechanisms 50, the peripheral portions, at which the pressing force is comparatively high during mold pressing, are heated to comparatively low temperatures, and the interior/intermediate portions, at which the pressing force is comparatively low, are heated to higher temperatures than the peripheral portions. That is, appropriate heating is performed, corresponding to the pressing force distribution during mold pressing, in the mold 12 and in the transfer substrate 20, and by this means the fine concavity and convexity pattern of the mold 12 can be transferred uniformly to the transfer layer 22 on the substrate 21.

The outer shape of the heating mechanisms 50 is not limited to a circular shape, but may be a polygon shape, as shown in (b) of FIG. 4, according to the outer shape of the transfer substrate 20 and mold 12. In this case also, the heating mechanisms 50 have heating regions divided into an interior/intermediate portion and a peripheral portion, configured so as to induce a temperature distribution according to the pressing force distribution.

Thus by means of a thermal imprinting device of the third embodiment of the invention, heating regions are divided in the circumferential direction in the heating mechanisms which heat the mold and the transfer substrate, and the constituent materials of the heating members having heat-generating elements are made different for each heating region according to the pressure distribution during mold pressing, so that a temperature distribution can formed so as to correct the non-uniform pressure distribution during mold pressing. The mold and transfer substrate are heated at a temperature distribution so as to correct the edge effect occurring during mold pressing, so that the fine concavity and convexity pattern of the mold can be transferred, uniformly and accurately, to the transfer layer of the transfer substrate. Moreover, in a thermal imprinting device of this invention, there is no need for an adjustment operation or for preparation of elastic members or other components to render the mold pressing force uniform, so that the number of components of the device can be reduced.

The materials comprised by heating members are not limited to metals, and ceramics, synthetic resins, or similar may be used, taking into consideration the pressing force distribution during mold pressing and other factors.

1. A thermal imprinting device, which heats a mold on the surface of which a concavity and convexity pattern is formed and a transfer substrate having a thermoplastic transfer layer on a substrate to a prescribed temperature, and then transfers the concavity and convexity pattern shape of the mold to the transfer layer,
the device comprising:
a pressing mechanism which brings the mold and the transfer layer into close contact to perform pressing; and
a heating mechanism arranged at position enclosing the mold and the transfer substrate to heat the mold and the transfer substrate, wherein
the heating mechanism has a plurality of heating regions, comprising a central heating region and at least one peripheral heating region surrounding the central heating region, and each of the heating regions has different heating ability,
the heating mechanism has: heat-generating elements provided independently in each of the central heating region and in the peripheral heating region; and heater having each of the heat-generating elements, and
the heat-generating elements belonging to the central heating regions, and the heat-generating elements belonging to the peripheral heating regions, are arranged at positions which are different from each other in the direction approaching/receding from the mold and the transfer substrate within the heater.

2. (canceled)

3. The thermal imprinting device according to claim 1, wherein the heat-generating elements belonging to the central heating regions are arranged at positions closer to the mold and to the transfer substrate within the heater, than the heat-generating elements belonging to the peripheral heating regions.

4. The thermal imprinting device according to claim 1, wherein
the pressing mechanism comprises: a mold holding portion which has a flat holding face, and which holds the mold on the holding face; a transfer substrate holding portion which has a flat holding face opposite the mold holding portion, and which holds the transfer substrate on the holding face; and a pressing portion which elevates at least one of the mold holding portion and the transfer substrate holding portion, and which applies a pressing force, and wherein
the heater abut each of faces of the mold holding portion and the transfer substrate holding portion on the sides opposite each of the holding faces.

5. A thermal imprinting device, which heats a mold on the surface of which a concavity and convexity pattern is formed and a transfer substrate having a thermoplastic transfer layer on a substrate to a prescribed temperature, and then transfers the concavity and convexity pattern shape of the mold to the transfer layer,
the device comprising:
a pressing mechanism which brings the mold and the transfer layer into close contact to perform pressing; and
a heating mechanism arranged at position enclosing the mold and the transfer substrate to heat the mold and the transfer substrate, wherein
the heating mechanism has a plurality of heating regions, comprising a central heating region and at least one peripheral heating region surrounding the central heating region, and each of the heating regions has different heating ability,
the heating mechanism includes the heat-generating elements independently in each of the central heating regions and the peripheral heating regions, and controller for individually controlling each of heat-generating temperatures of the heat-generating elements, and
the controller causes the heat-generating temperatures of the heat-generating elements belonging to the central heating regions to be different from the heat-generating temperatures of the heat-generating elements belonging to the peripheral heating regions.

6. The thermal imprinting device according to claim 5, wherein the control means executes control such that the heat-generating temperatures of the heat-generating elements belonging to the central heating regions are higher than the heat-generating temperatures of the heat-generating elements belonging to the peripheral heating regions.

7. The thermal imprinting device according to claim 5, wherein
the pressing mechanism comprises: a mold holding portion which has a flat holding face, and which holds the mold on the holding face; a transfer substrate holding portion which has a flat holding face opposite the mold holding portion, and which holds the transfer substrate on the holding face; and a pressing portion which elevates at least one of the mold holding portion and the transfer substrate holding portion, and which applies a pressing force, and wherein
the heat-generating elements are provided within the mold holding portion and the transfer substrate holding portion.

8. The thermal imprinting device according to claim 5, wherein
the pressing mechanism comprises: a mold holding portion which has a flat holding face, and which holds the mold on the holding face; a transfer substrate holding portion which has a flat holding face opposite the mold holding portion, and which holds the transfer substrate on the holding face; and a pressing portion which elevates at least one of the mold holding portion and the transfer substrate holding portion, and which applies a pressing force, and wherein
the heating mechanism further comprises heater having each of the heat-generating elements and abutting faces of the mold holding portion and the transfer substrate holding portion on the sides opposite the holding faces.

9. A thermal imprinting device, which heats a mold on the surface of which a concavity and convexity pattern is formed and a transfer substrate having a thermoplastic transfer layer on a substrate to a prescribed temperature, and then transfers the concavity and convexity pattern shape of the mold to the transfer layer,
the device comprising:
a pressing mechanism which brings the mold and the transfer layer into close contact to perform pressing; and
a heating mechanism arranged at position enclosing the mold and the transfer substrate to heat the mold and the transfer substrate, wherein
the heating mechanism has a plurality of heating regions, comprising a central heating region and at least one peripheral heating region surrounding the central heating region, and each of the heating regions has different heating ability,
the heating mechanism has heat-generating elements provided independently in each of the central heating regions and the peripheral heating regions, and heater having the heat-generating elements, and wherein the heater formed of materials having different thermal conductivities in each of the heating regions.

10. The thermal imprinting device according to claim 9, wherein the heater belonging to the central heating regions are formed of materials having higher thermal conductivities than the heater belonging to the peripheral heating regions.

11. The thermal imprinting device according to claim 9, wherein
the pressing mechanism comprises: a mold holding portion which has a flat holding face, and which holds the mold on the holding face; a transfer substrate holding portion which has a flat holding face opposite the mold holding portion, and which holds the transfer substrate on the holding face; and a driving portion which elevates at least one of the mold holding portion and the transfer substrate holding portion, and which applies a pressing force, and wherein
the heater abut each of faces of the mold holding portion and the transfer substrate holding portion on the sides opposite each of the holding faces.

12. The thermal imprinting device according to claim 4, wherein
each of the mold holding portion and the transfer substrate holding portion has a plurality of heated regions corresponding to each of the central and peripheral heating regions, and has adiabatic members which partition each of the heated regions.

13. The thermal imprinting device according to claim 1, wherein
the heating mechanism has adiabatic members which partition the central heating regions and the peripheral heating regions.

14. (canceled)

15. A thermal imprinting method, in which a transfer substrate having a thermoplastic transfer layer on a substrate and a mold on the surface of which a concavity and convexity pattern is formed are heated, and then the mold is pressed against the transfer layer to transfer the concavity and convexity pattern shape of the mold to the transfer layer, the method comprising:
a setup step of setting up the transfer substrate and the mold such that the transfer layer and the concavity and convexity pattern formation face of the mold are opposed;
a heating step of heating the mold and the transfer substrate and causing softening of the transfer layer;
a pressing step of bringing the transfer layer and concavity and convexity pattern formation face of the mold into close contact to perform pressing;
a hardening step of cooling the transfer substrate and the mold, and causing hardening of the transfer layer; and
a separating step of separating the transfer substrate and the mold; wherein
the heating step, the transfer layer is heated at a non-uniform temperature distribution in the from the inner to outer circumferential direction of the transfer substrate in the region to which the concavity and convexity pattern shape is to be transferred by a heating mechanism, and wherein
the heating mechanism has a plurality of heating regions, comprising a central heating region and at least one peripheral heating region surrounding the central heating region, and each of the heating regions has different heating ability, and
the heating mechanism has: heat-generating elements provided independently in each of the central heating region and in the peripheral heating region; and heater having each of the heat-generating elements, and
the heat-generating elements belonging to the central heating regions, and the heat-generating elements belonging to the peripheral heating regions, are arranged at positions which are different from each other in the direction approaching/receding from the mold and the transfer substrate within the heater.

16. The thermal imprinting method according to claim 15, wherein the heating step is a step of heating the inner side of the transfer layer to a higher temperature than the peripheral side.
